(19) United States
(12) Patent Application Publication
(10) Pub. No.: US 2025/0252069 A1
(43) Pub. Date: Aug. 7, 2025

(54) MULTI-PROCESSING UNIT DATA MOVEMENT TECHNIQUES

(71) Applicant: MemryX Incorporated, Ann Arbor, MI (US)

(72) Inventors: Chester LIU, Ann Arbor, MI (US); Jayadev DEVAGIRI, Ann Arbor, MI (US)

(21) Appl. No.: 19/014,068

(22) Filed: Jan. 8, 2025

Related U.S. Application Data
(63) Continuation-in-part of application No. 18/109,736, filed on Feb. 14, 2023.
(60) Provisional application No. 63/310,031, filed on Feb. 14, 2022.

(51) Int. Cl. G06F 13/20

(52) U.S. Cl. CPC G06F 13/20; G06F 2213/40

(57) ABSTRACT

Data movement techniques for multi-processor computing devices utilize a transfer address including a retarget address field, one or more control fields and a chip identifier field. The retarget address field identifies a dataspace of a host processor or given accelerator processors. The one or more control fields indicate a dataflow transfer or a configuration transfer. The chip identifier field indicates a destination accelerator processor. The transfer address can optional also include a flow identifier field indicating an applicable dataflow register for a dataflow transfer.

### CROSS-REFERENCE TO RELATED APPLICATIONS

This is a continuation-in-part of U.S. patent application Ser. No. 18/109,736 filed Feb. 14, 2023, which claims priority to U.S. Provisional Patent Application No. 63/310,031 filed Feb. 14, 2022, both of which are incorporated herein in their entirety.

### BACKGROUND OF THE INVENTION

A number of computing devices include multiple processing units. For example, a computing device can include a host processor and one or more accelerator processors as illustrated in FIGS. 1 and 2. As used herein the term accelerator processor can also include slave processors, edge processors, coprocessors, controllers, graphics processors, digital signal processors, and the like. As illustrated in FIG. 1, a computing device 100 can include a host processor 110 coupled to an accelerator processor 120 by one or more communication interfaces 130, 140. In other cases, the computing device 200 can include a host processor 210 coupled to a plurality of accelerator processors 220-1, 220-X by a plurality of communication interfaces 230-1, 230-X, 240-1, 240-X, as illustrated in FIG. 2. The one or more accelerator processors can be configured to accelerate one or more functions such as but not limited to machine learning, artificial intelligence and big data analytics.

For the multi-processing unit computing devices, there is a continuing need for techniques that support different types of transactions while also providing for efficient data movement.

### SUMMARY OF THE INVENTION

The present technology may best be understood by referring to the following description and accompanying drawings that are used to illustrate embodiments of the present technology directed toward multi-processing unit data movement techniques.

Aspects of the present technology advantageously supports different types of read and write transactions. A consistent memory map can advantageously be seen by the host processor regardless of the number of accelerator processors. Aspects advantageously enable a host driver to stream data to the plurality of accelerator processors. Configuration data can tolerate relatively large latency, and stream data can be sent quickly and efficiently. In aspects, efficient data movement can advantageously be controlled by hardware.

In one embodiment, a multi-processor data movement method can include setting a retarget address field of a transfer address one or more times to a dataspace of one or more processors. The method can further include setting one or more control fields to indicate a dataflow transfer or a configuration transfer, and setting a chip identifier field to indicate a destination processor. The method can further include routing the transfer address to the destination processor based on the retarget address field, the one or more control fields and the chip identifier field.

In another embodiment, a multi-processor computing device can include a host processor and a plurality of accelerator processor coupled in series to the host processor by respective communication interfaces that support configuration transfers and dataflow transfers utilizing a transfer address including a retarget address field, one or more control fields, a chip identifier field, and optionally a flow identifier field. The retarget address field identifies a dataspace of a host processor or given accelerator processors. The one or more control fields indicate a dataflow transfer or a configuration transfer. The chip identifier field indicates a destination accelerator processor. The optional flow identifier field indicates an applicable dataflow register for a dataflow transfer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

Embodiments of the present technology are illustrated by way of example and not by way of limitation, in the figures of the accompanying drawings and in which like reference numerals refer to similar elements and in which:

FIG. 1 shows a computing device according to the conventional art.

FIG. 2 shows another computing device according to the conventional art.

FIG. 3 shows a computing device, in accordance with aspects of the present technology.

FIG. 4 shows a computing device, in accordance with aspects of the present technology.

FIG. 5 shows a computing device, in accordance with aspects of the present technology.

FIG. 6 shows a computing device, in accordance with aspects of the present technology.

FIGS. 7A-7D show an address-based decoding technique, in accordance with aspects of the present technology.

FIG. 8 shows an accelerator processor, in accordance with aspects of the present technology.

FIG. 9 shows an accelerator processor, in accordance with aspects of the present technology.

FIGS. 10A-10C show address-based decoding examples, in accordance with aspects of the present technology.

FIGS. 11A-11B show an exemplary data write, in accordance with aspects of the present technology.

FIGS. 12A-12B show an exemplary data write, in accordance with aspects of the present technology.

FIGS. 13A-13D show an exemplary data write, in accordance with aspects of the present technology.

FIGS. 14A-14H show an exemplary control information write, in accordance with aspects of the present technology.

FIG. 15 shows a waveform set for an exemplary control information write, in accordance with aspects of the present technology.

FIGS. 16A-16B show an exemplary control information write, in accordance with aspects of the present technology.

FIG. 17 shows a waveform set for an exemplary control information write, in accordance with aspects of the present technology.

FIG. 18 shows a computing device, in accordance with aspects of the present technology.

FIG. 19 shows an exemplary memory space of a host processor, in accordance with aspects of the present technology.

FIGS. 20A-20B show a multi-processing unit data movement method, in accordance with aspects of the present technology.

FIGS. 21A-21C show a multi-processing unit data movement method, in accordance with aspects of the present technology.

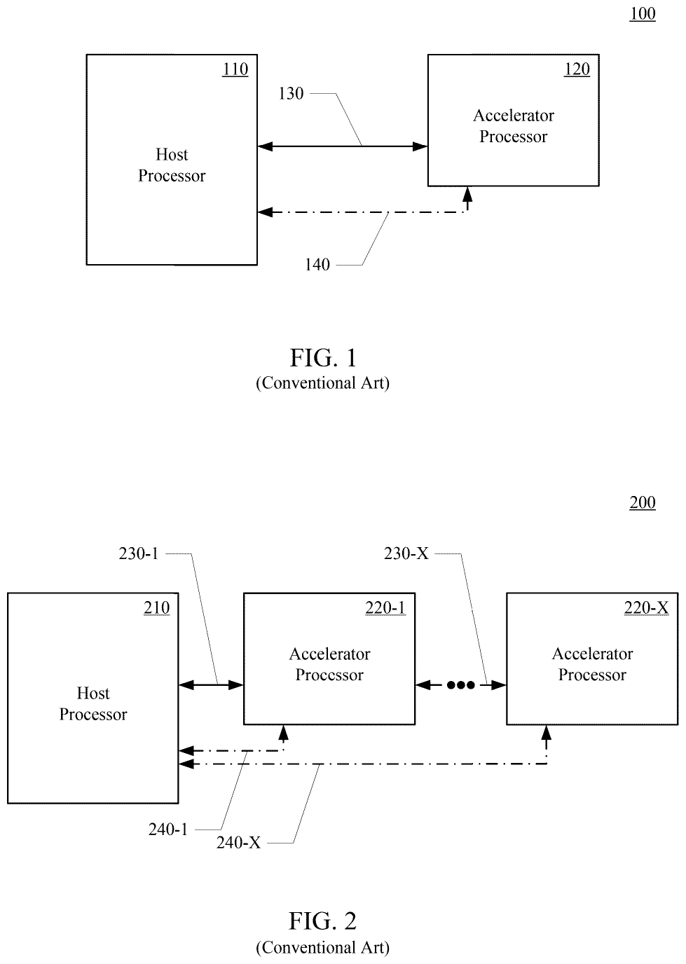

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the technology to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. The use of the terms “comprises,” “comprising,” “includes,” “including” and the like specify the presence of stated elements, but do not preclude the presence or addition of one or more other elements and or groups thereof. It is also to be understood that although the terms first, second, etc. may be used herein to describe various elements, such elements should not be limited by these terms. These terms are used herein to distinguish one element from another. For example, a first element could be termed a second element, and similarly a second element could be termed a first element, without departing from the scope of embodiments. It is also to be understood that when an element is referred to as being “coupled” to another element, it may be directly or indirectly connected to the other element, or an intervening element may be present. In contrast, when an element is referred to as being “directly connected” to another element, there are not intervening elements present. It is also to be understood that the term “and or” includes any and all combinations of one or more of the associated elements. It is also to be understood that the phraseology and terminology used herein is for the purpose of description and should not be regarded as limiting.

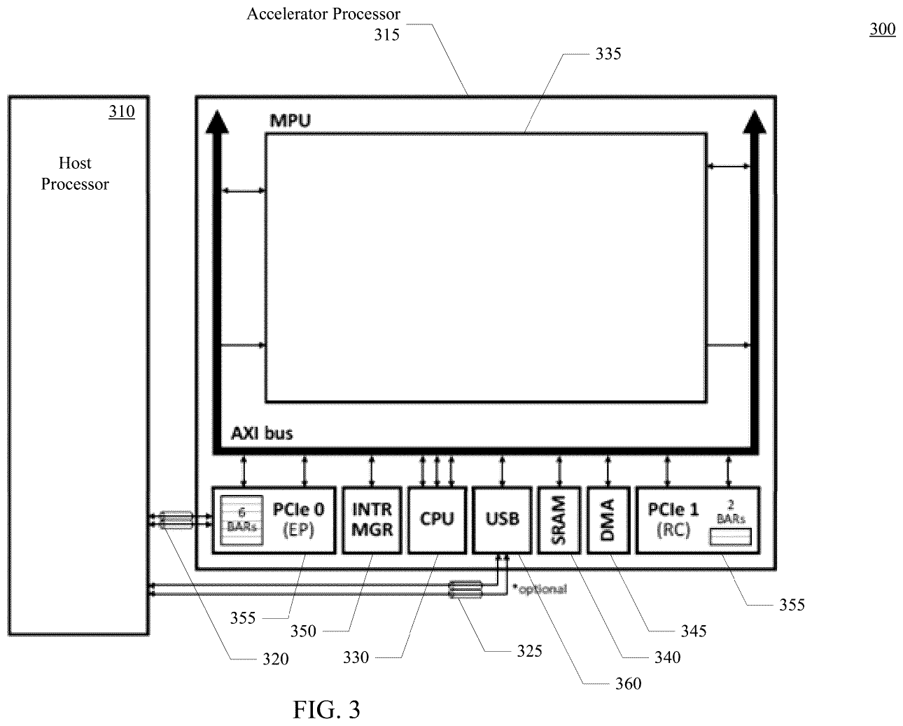

Referring now to FIG. 3, a computing device, in accordance with aspects of the present technology, is shown. The computing device 300 can include a host processor 310 and an accelerator processor 315 coupled by one or more communication channels 320, 325. The accelerator processor 315 can include a plurality of functional modules coupled by one or more communication buses 320, 325. The functional modules can include, but are not limited to, one or more central processing units (CPUs) 330, one or more memory processing units (MPUs) 335, one or more memories 340, one or more memory management unit (e.g., direct memory access (DMA)) 345, one or more controllers (e.g., integrated manager) 350, and one or more communication interfaces 355, 360. The host processor 310 can similarly include a plurality of functional modules coupled by one or more communication buses. In one implementation, the host processor 310 is coupled to the accelerator processor 315 by a peripheral component interface express (PCIe) communication interface 320. The host processor 310 can be further coupled to the accelerator processor 315 by a universal serial bus (USB) interface 325. The accelerator processor 315 can be configured to accelerate one or more functions such as machine learning, artificial intelligence and the like functions.

The plurality of communication interfaces 320, 325 can be adapted for configuration writes from the host processor 310 to the accelerator processor 315, and configuration reads from the accelerator processor 315 to the host processor 310, and from the host processor 310 to the accelerator processor 315. Configuration writes are adapted for the host processor 310 to program modules of the accelerator processor 315. Configuration writes are typically performed infrequently, for example at initialization of the accelerator processor 315 and for model swapping. Configuration reads are adapted for reading memory spaces, typically for debugging purposes. The plurality of communication interfaces 320, 325 can also be adapted for input streaming from the host processor 310 to the accelerator processor 315, and output streaming from the accelerator processor 315 to the host processor 310. The stream input is adapted to send input data (e.g., inference data) from the host processor 310 the accelerator processor 315, and can include one or more streams running in parallel. The steam output is adapted to send output date (e.g., inference data) from the accelerator processor 315 the host processor 310, and can include one or more streams running in parallel.

Configuration writes can be provided by a relatively low bandwidth communication channel and can be subject to relatively high latency. In an exemplary implementation, it may take on the order of 10 MB of data to program an entire accelerator processor 315. Similarly, configuration reads can also be provided by a relatively low bandwidth communication channel. Stream inputs and stream outputs can be provided by a relatively high bandwidth communication channel with relatively low latency. In an exemplary implementation, a communication channel providing a bandwidth on the order of 1 GB/s or more may be utilized to stream inputs and stream outputs.

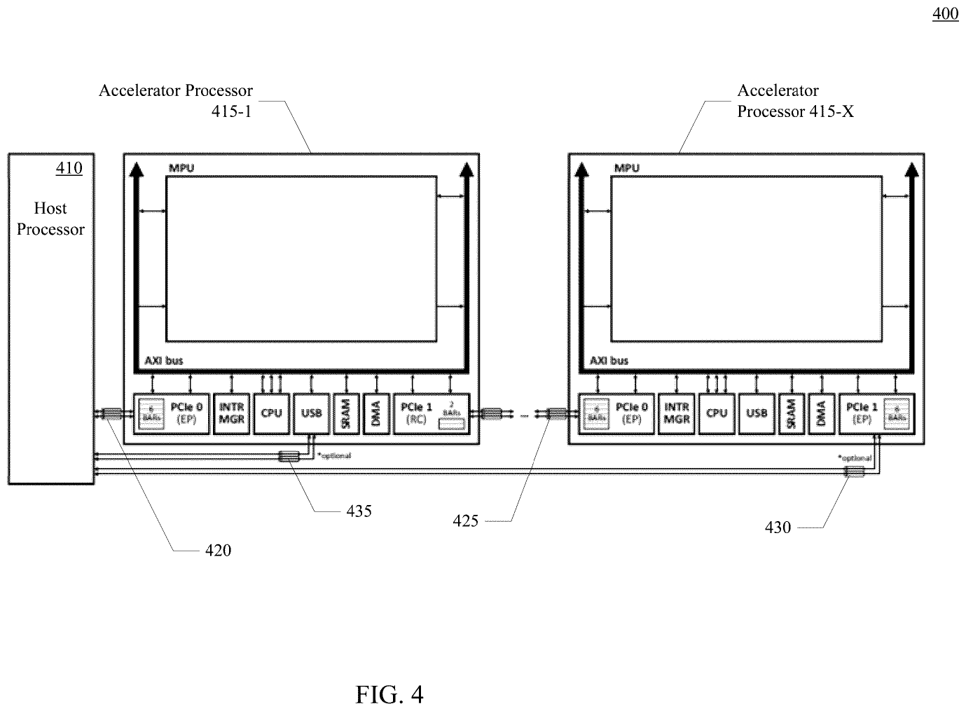

Referring now to FIG. 4, a computing device, in accordance with aspects of the present technology, is shown. The computing device 400 can include a host processing unit 410 coupled to a plurality of accelerator processors 415-1, 415-X by a plurality of communication interfaces 420-435. In one implementation, the host processor 410 can be coupled to the plurality of accelerator processors 415-1, 415-X in series by a plurality of PCIe interfaces 420-430 sequentially communicatively coupling the accelerator processors and the host processor. Optionally, the host processor 410 can also be coupled to one or more of the accelerator processors 415-1 by a corresponding USB interface 435. In one implementation, a first and last accelerator processor in the series coupled accelerator processors 415-1, 415-X can be coupled to the host processor 410 by PCIe interfaces 420-430. However, if a PCIe interface 430 coupling the last accelerator processor 415-X back to the host processor 410 is not provided, data can traverse backward through the series coupled accelerator processors 415-X, 415-1 to the first accelerator processor 415-1 and then to the host processor 410. The communication channels coupling the host processor 410 to the plurality of accelerator processors 415-1, 415-X, and the accelerator processors 415-1, 415-X together in series can support configuration writes and reads, and stream inputs and outputs as described above with reference to a host processor 310 coupled to a single accelerator processor 315, such that the host processor can configure read and write with any accelerator processor, and stream input and output to any accelerator processor. Furthermore, stream inputs and outputs can be performed chip-to-chip between the accelerator processors.

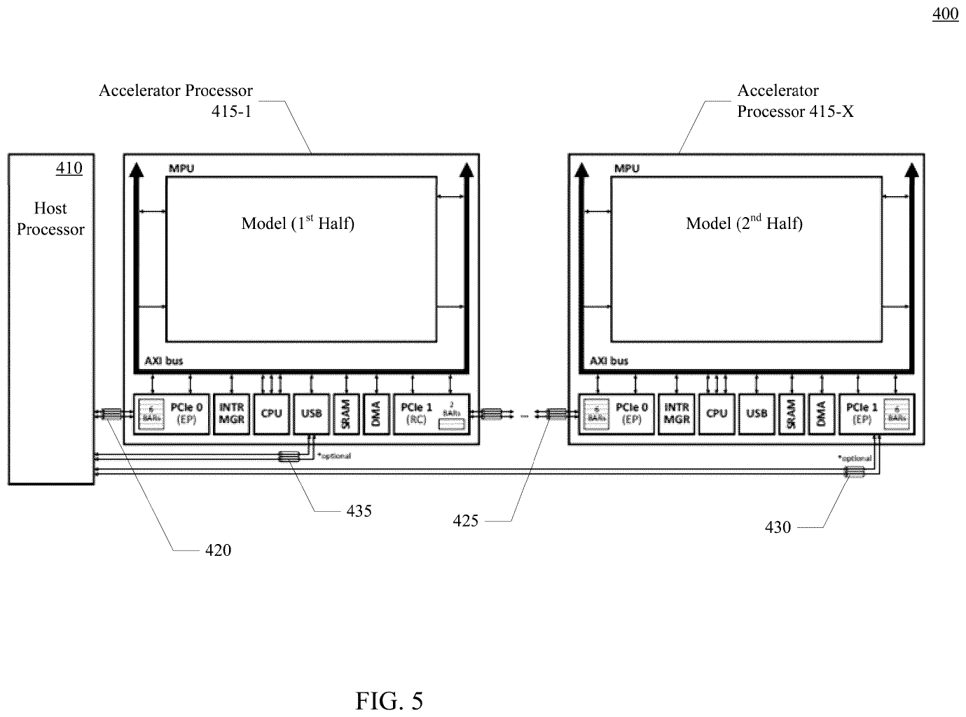

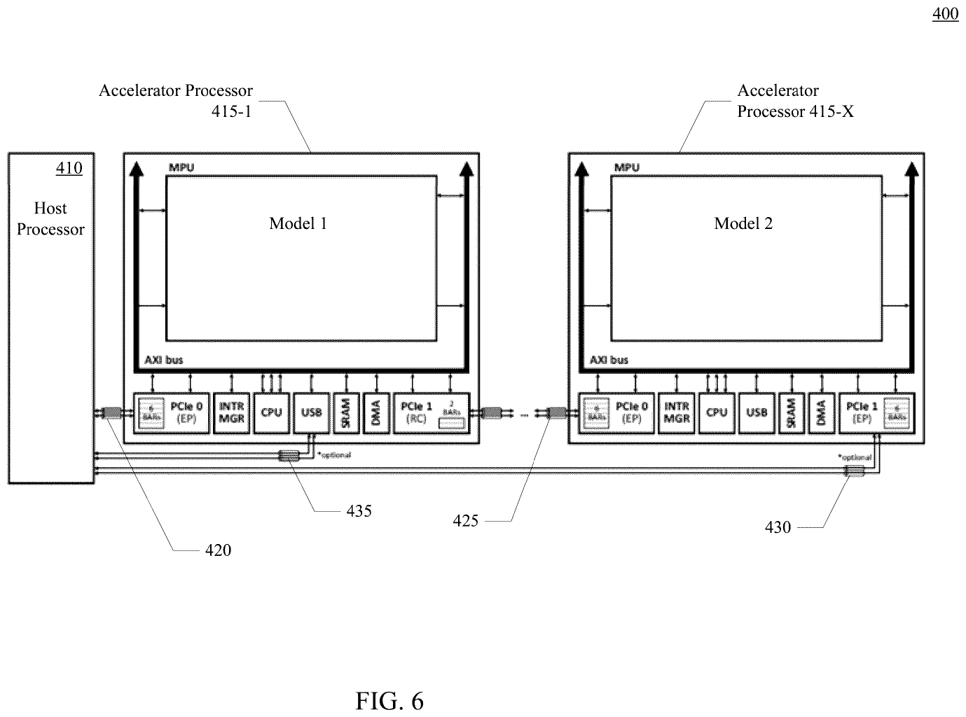

In an exemplary implementation, the host processor 410 can program a first accelerator processor 415-1 with a first portion of a computation model, and a second accelerator processor 415-X with a second portion of the computation model, as illustrated in FIG. 5. The computation model can be an artificial intelligence model, a machine learning model or the like. Thereafter, inference data can flow by stream inputs from the host processor 410 to the first accelerator processor 415-1, and from the first accelerator processor 415-1 to the second accelerator processor 415-X. Similarly, inference results can flow by stream outputs from the second accelerator processor 415-X to the first accelerator processor 415-1, and from the first accelerator processor 415-1 to the host processor 410. In another exemplary implementation, the host processor 410 can program a first accelerator processor 415-1 with a first model, and a second accelerator processor 415-X with a second model, as illustrated in FIG. 6. Thereafter, inference data can flow by stream inputs from the host processor 410 to the first accelerator processor 415-1, and from the host processor 410 to the second accelerator processor 415-X. Likewise, inference results can flow from the first accelerator processor 415-1 the host processor 410, and from the second accelerator processor 415-X to the host processor 410.

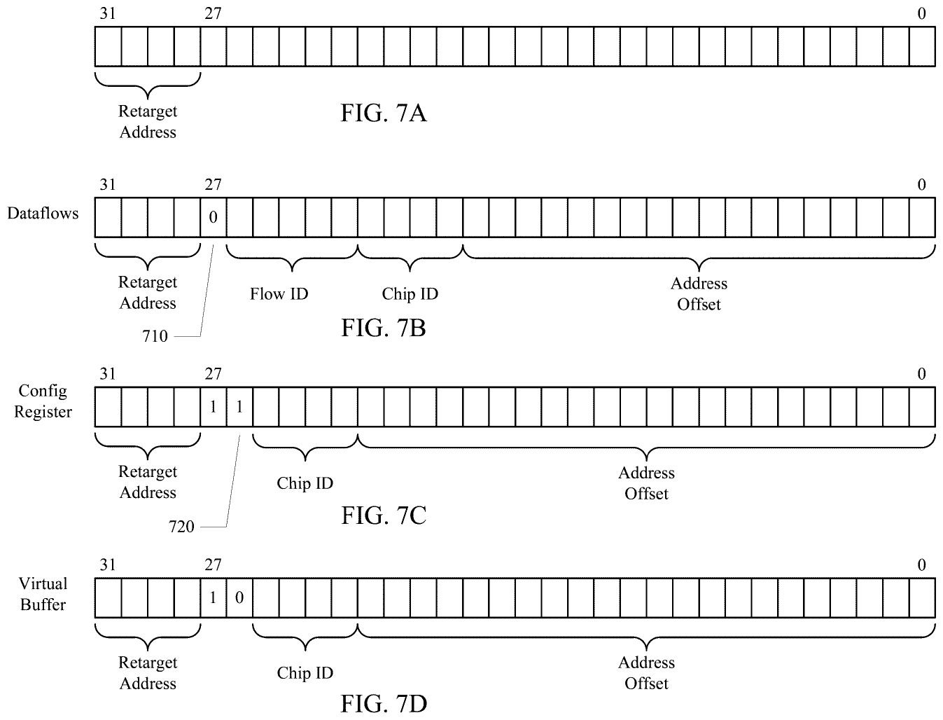

Referring now to FIGS. 7A-7D, an address-based decoding technique, in accordance with aspects of the present technology, is shown. A fixed number of address bits can be allocated on the host processor and the one or more accelerator processors to address the respective memory spaces, as illustrated in FIG. 7A. In one implementation, 28 bits of a 32-bit address can be allocated on the host processor. The 28-bit address provides for 256 MB of addressable memory space on the host processor. The remaining four bits of the address can be configured as a retarget address field. The retarget address can be different at the host processor, the accelerator processor, and the ports of the communication interfaces. In one implementation, the retarget address for the accelerator processor can be 0x3, the retarget address for the PCIe port 0 can be 0x5, and the retarget address for the PCIe port 1 can be 0x6. Table 1 shows an exemplary memory space for the data port (DI port) of the one or more accelerator processor, the control port (CI port) of the one or more accelerator processors, the PCIe0 (EP) data port, and PCIe (RC) data port.

| Module | Start Address | End Address | Size |
|---|---|---|---|
| Acc. Proc. DI Port | 0x3000_0000 | 0x37FF_FFFF | 128 MB |
| Acc. Proc. CI Port | 0x3800_0000 | 0x3FFF_FFFF | 128 MB |
| PCIe0 (EP) Data Port | 0x5000_0000 | 0x5FFF_FFFF | 256 MB |
| PCIe1 (RC) Data Port | 0x6000_0000 | 0x6FFF_FFFF | 256 MB |

The address field can include a first control bit (e.g., bit 27) 710, wherein a first bit value (e.g., 0) can indicate a dataflow as illustrated in FIG. 7B, and a second bit value (e.g., 1) can indicate a control flow as illustrated in FIGS. 7C and 7D. For a dataflow the address field can further include a flow identifier field (e.g., bits 22-26), a chip identifier field (e.g., bits 18-21) and an address offset field (e.g., bits 0-17). For a control flow, the address field can further include a second control bit (e.g., bit 26) 720, wherein a first bit value (e.g., 0) can indicate a flow to a configuration register, and a second bit value (e.g., 1) can indicate a flow to a virtual buffer. For a control flow, the address field can further include a chip identifier field (e.g., bits 22-25) and an address offset field (e.g., bits 0-21).

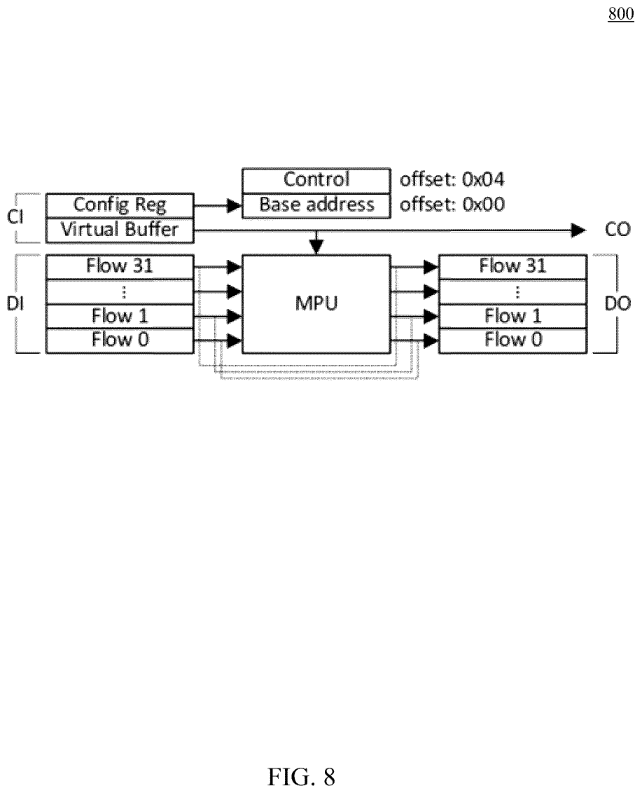

Referring now to FIG. 8, an accelerator processor, in accordance with aspects of the present technology, is shown. The accelerator processor 800 can include one or more processing units, a control register, a base address register, a control in (CI) configuration register, a control in (CI) virtual buffer, a plurality of data in (DI) buffers (e.g., Flow0-Flow31), and plurality of data out (DO) buffers (e.g., Flow0-Flow31). In one implementation, the one or more processing units can be memory processing units (MPUs), neural processing units (NPUs) or the like. The memory processing units can further include the memory processing units as described in U.S. patent application Ser. No. 17,943,100 filed Sep. 12, 2022, and U.S. patent application Ser. No. 18/109,736 filed Feb. 14, 2023, both of which are incorporated herein by reference.

Referring again to FIG. 7B, for a dataflow, the flow identifier field can indicate a selected data in (DI) buffer (e.g., one of a plurality of data streams). The chip identifier field can indicate one of a plurality of accelerator processors. If for example, the first control bit 710 is set to a first value (e.g., 0), the dataflow can be sent to a data in (DI) AXI port and a flow buffer specified by the flow identifier field, of a given accelerator processor specified by the chip identifier field.

Referring to FIGS. 7C and 7D, for a control flow, the chip identifier field can indicate one of a plurality of accelerator processors. If, for example, the first control bit 710 is set to a second value (e.g., 1) and the second control bit 720 is set to a second value (e.g., 1), the configuration data can be sent to the configuration register of the configuration in (CI) AXI port of a given accelerator processor specified by the chip identifier field. If the first control field 710 is set to the second value (e.g., 1) and the second control bit 720 is set to a first value (e.g., 0) the configuration data can be sent to the virtual buffer of the configuration in (CI) AXI port of a given accelerator processor specified by the chip identifier field.

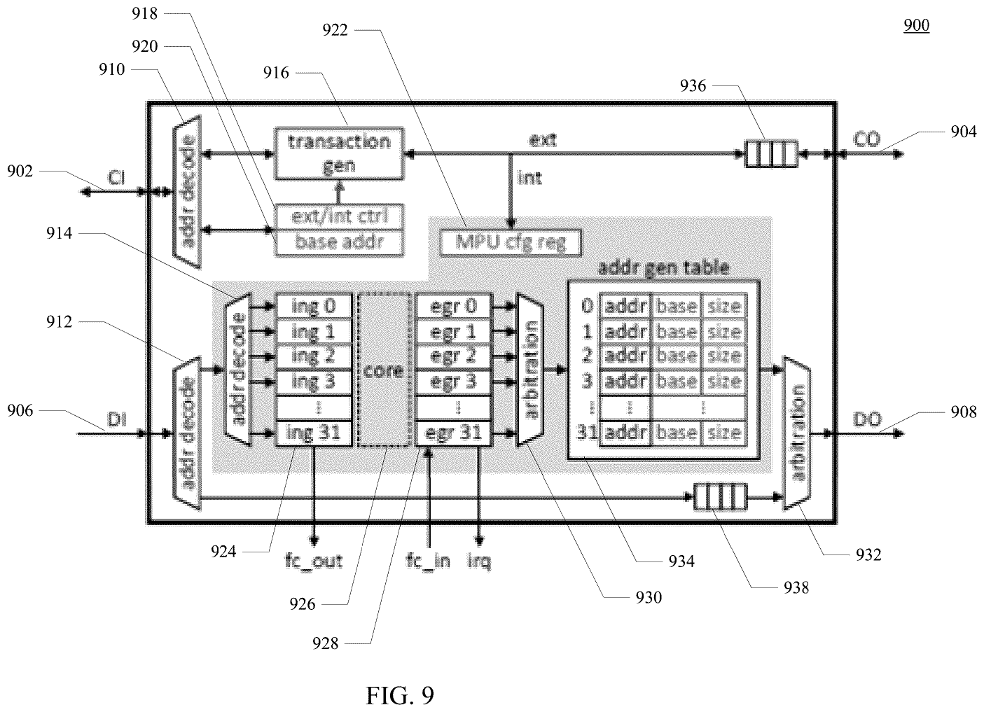

Referring now to FIG. 9, an accelerator processor, in accordance with aspects of the present technology, is shown. The accelerator processor 900 can include a control in (CI) port 902 and a control out (CO) port 904. The accelerator processor 900 can also include a data in (DI) port 906 and a date out (DO) port 908. The accelerator processor 900 can further include first, second and third address decoders 910-914, a transaction generation module 916, an external/internal control register 918, a base address register 920, an accelerator configuration register 922, a plurality of ingress registers 924, one or more cores 926, a plurality of egress registers 928, first and second arbitration modules 930, 932, and address generation table 934, a control out buffer 936 and a data out buffer 938. In one implementation, the one or more cores can further include the memory processing units as described in U.S. patent application Ser. No. 17,943,100 filed Sep. 12, 2022, and U.S. patent application Ser. No. 18/109,736 filed Feb. 14, 2023, both of which are incorporated herein by reference.

The first address decoder 910 can be coupled between the control input (CI) port 902 and the address transaction generation module 916, the external/internal control module 918 and the base address register 920. The transaction generation module 916 can be coupled to the control output buffer 936 of the control out (CO) port 904, and the accelerator configuration register 922. The second address decoder 912 and the third address decoder 914 can be coupled to the data in (DI) port 906. The second address decoder 912 can decode a first portion of a dataflow address received on the data in (DI) port 906 and selectively route the dataflow to a data buffer 938 of the data out port 908. The third address decoder 914 can decode a second portion of the dataflow address received on the data in (DI) port 906 and selectively route the dataflow to a given ingress buffer 924 based on the flow identifier. The one or more processor cores 926 can be disposed between the ingress buffers 924 and the egress buffers 928. The first arbitration module 930 can be coupled between the egress buffers 928 and the address generation table 934. The address generation table 934 and the data out buffer 938 can be coupled to the second arbitration module 932, with the output of the second arbitration module 932 coupled to the data out (DO) port 908.

Upon receiving a control input, if the first and second control bits (e.g., bits 27 and 26) 710, 720 and the chip identifier field indicate that the control input is not for the present accelerator processor, the transaction generation module 916 can change the retarget address from a value specifying an accelerator processor to a value specifying the control out (CO) port (e.g., PCIe1), and thereafter the changed control input can be sent to the control output buffer 936 for output on the control out port 904 to the next accelerator processor in the series coupled plurality of accelerator processors. If the control input is for the present accelerator processor, the address offset can be changed to the sum of the base address register 920 and the address offset, and the control input can be sent to the accelerator configuration register 922. If the control input is for output from the present processor, the address offset can be set to the sum of the base address 920 and the address offset, and the changed control input can be sent to the control output buffer 936 for output on the control out (CO) port 904.

Upon receiving a dataflow input, if the first control bit 710 and the chip identifier field indicate that the dataflow input is not for the present accelerator processor, the retarget address field can be changed from a value specifying an accelerator processor to a value specifying the data output (DO) port (e.g., PCIe1) 908 and the changed dataflow can be sent to the data output buffer 938 for output on the data out (DO) port 908. The changed dataflow can be arbitrated with the egress data-core output of the accelerator processor. If the dataflow input is for the present accelerator processor, the dataflow can be sent to a respective ingress register 924 based upon the address for the dataflow, and onto the one or more processor cores 926. Results from the one or more processing cores can be output to egress registers 928. The egress registers 928 include a programmable base address register that can be programmed to target a next accelerator processor's data in (DI) port (e.g., PCIe0).

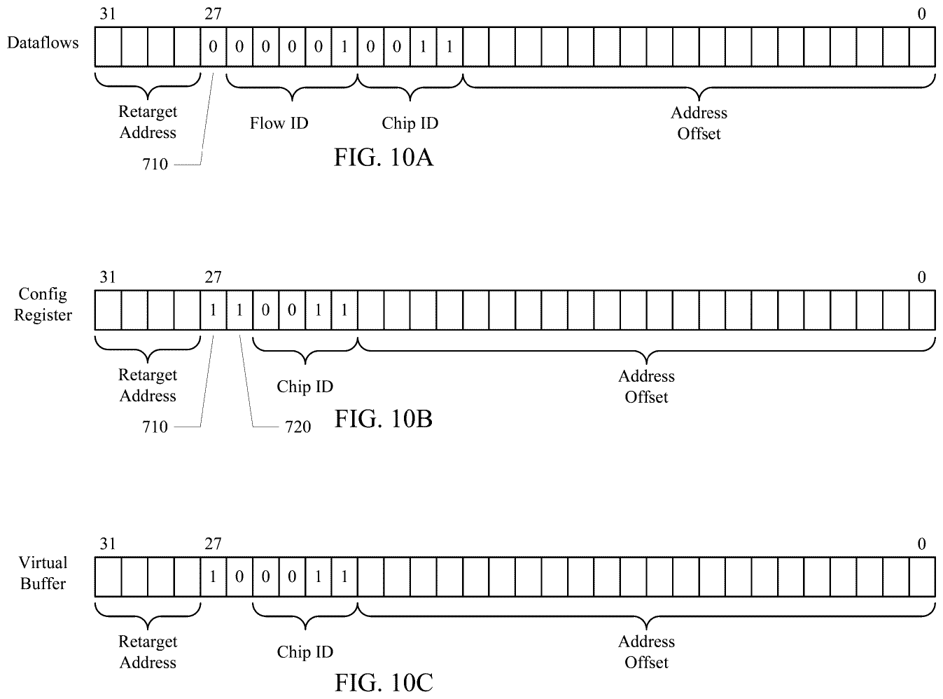

Referring now to FIGS. 10A-10C, address-based decoding examples, in accordance with aspects of the present technology, are shown. FIG. 10A illustrates a data write from the host to a memory space of a fourth accelerator processor (e.g., chip ID 0011) at an address based on the address offset. The first control bit 710 set to a first bit value (e.g., bit 27 set to 0) indicates a dataflow, the chip identifier value of 0011 indicates the data is for streaming to a third accelerator processor, with the flow identifier value of 00001. FIGS. 10B and 10C illustrate a configuration read from the host. The host first writes, as indicated by the first control bit 710 set to a second bit value (e.g., bit 27 set to 1) and the second control bit 720 set to the second bit value (e.g., bit 26 set to 1) indicating a write to the third accelerator processor as specified by the chip identifier value of 0011, as illustrated in FIG. 10B. The host then reads, as indicated by the first control bit 710 value of 1 and the second control bit 720 value of 0, from the specified address at the third accelerator processor as indicated by the chip identifier value of 0011.

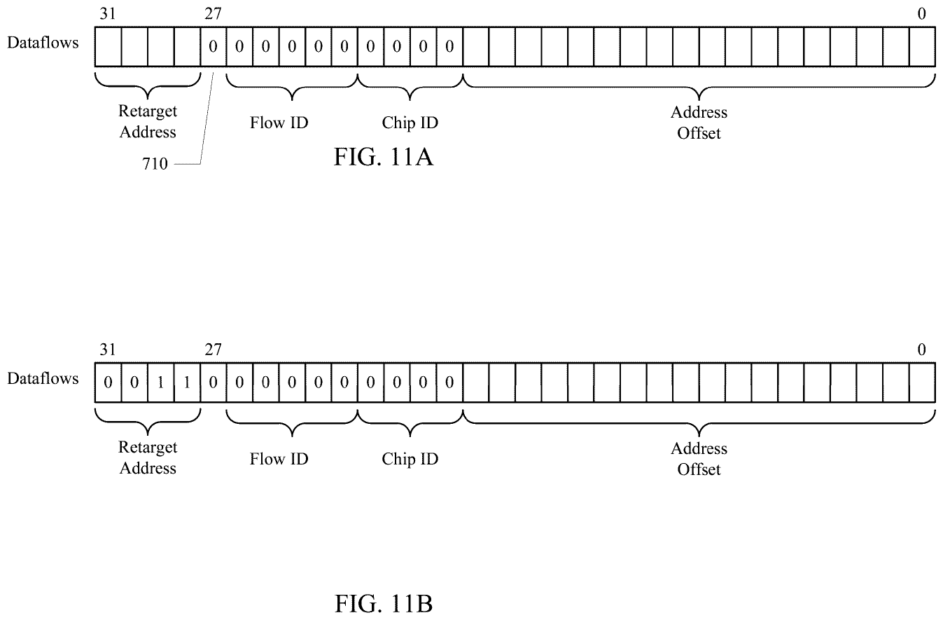

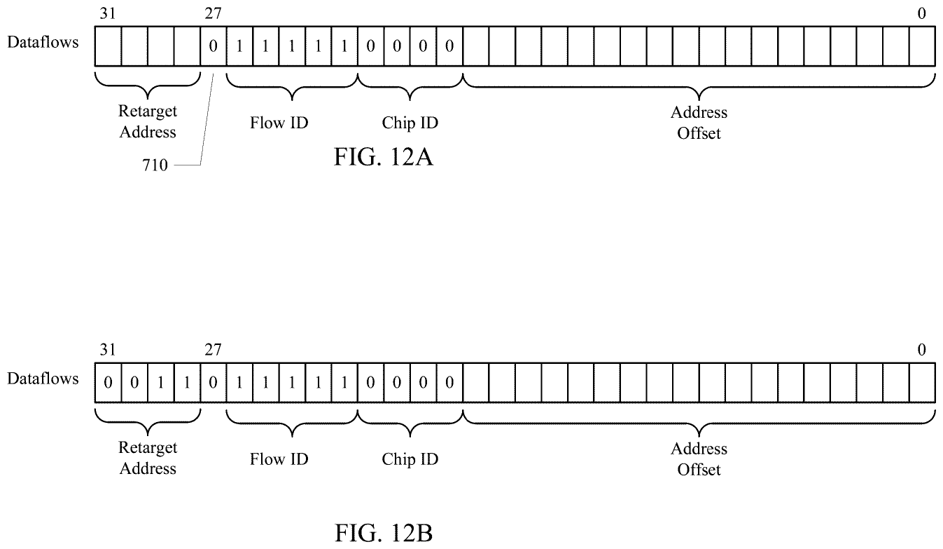

Referring now to FIGS. 11A and 11B, an example of writing data from a host to a first ingress data register (e.g., ing 0) of a first accelerator processor (e.g., chip ID 0000), in accordance with aspects of the present technology, is shown. The host processor can send the address and data from memory to its output port (e.g., PCIe). The address can have the first control bit 710 set to a first state to indicate a dataflow, the flow identifier set to a given value (e.g., flow ID 00000) to indicate a given ingress register (e.g., ing 0). The chip identifier can be set to a value specifying the first accelerator processor (e.g., chip ID 0000). The host processor at the output port sets the retarget address portion to a value indicating a data input (DI) port (e.g., 0x3), which is transmitted to the data input (DI) port of the first accelerator processor. FIGS. 12A and 12B show another example, wherein the host writes data to a last ingress data register (e.g., ing 31; flow ID 11111) of a first accelerator processor (e.g., chip ID 0000).

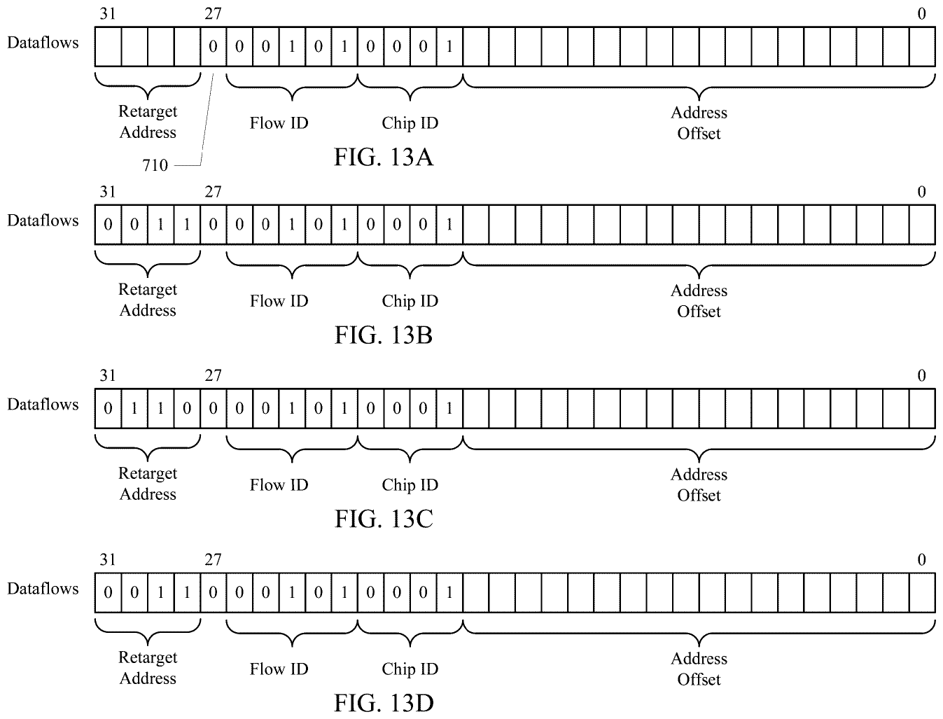

Referring now to FIGS. 13A-13D, another example of writing data from a host to a sixth ingress data register (e.g., ing 5) of a second accelerator processor, in accordance with aspects of the present technology, is shown. The host processor can send the address and data from memory to its output port (e.g., PCIe). The address can have the first control bit 710 set to a first state to indicate a dataflow, and the flow identifier set to a given value (e.g., flow ID 00101) to indicate the sixth ingress register (e.g., ing 5). The chip identifier can be set to specify the second accelerator processor (e.g., chip ID 0001). The host processor at the output port sets the retarget address portion to a value indicating a data input (DI) port (e.g., 0x3), which is transmitted to the data input (DI) port of the first accelerator processor. Upon receipt the first accelerator processor can change the retarget address portion to indicate the data out (DO) port (e.g., PCIe1; 0x6) of the first accelerator and sends the address and data to the data out (DO) port. The first accelerator processor at the output port sets the retarget address portion to a value indicating a data input (DI) port (e.g., 0x3) of the second accelerator processor (e.g., 0001), which is transmitted to the data input (DI) port of the second accelerator processor.

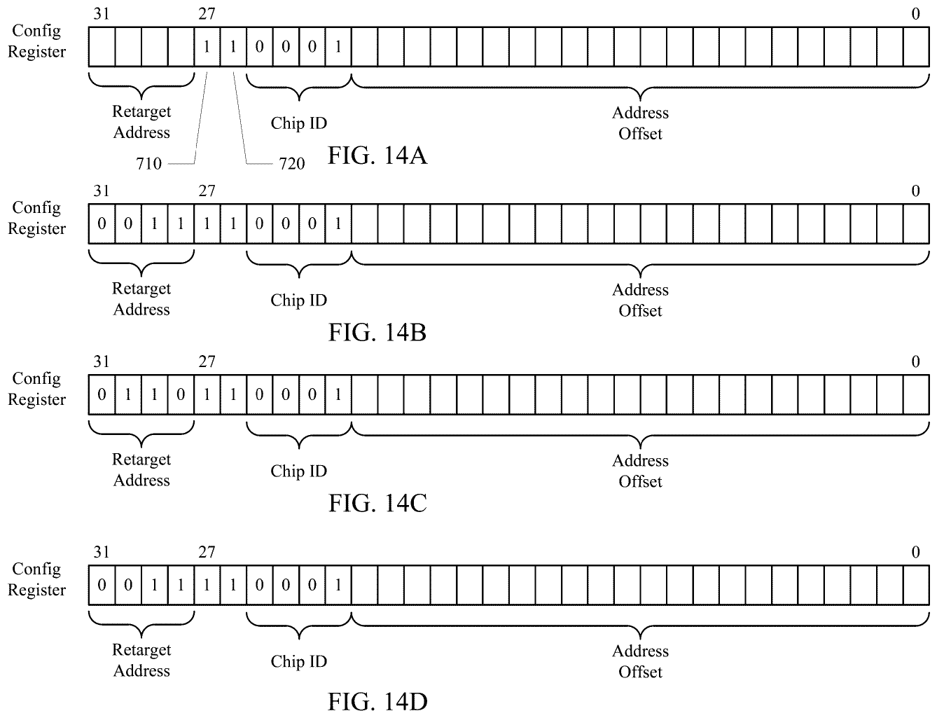

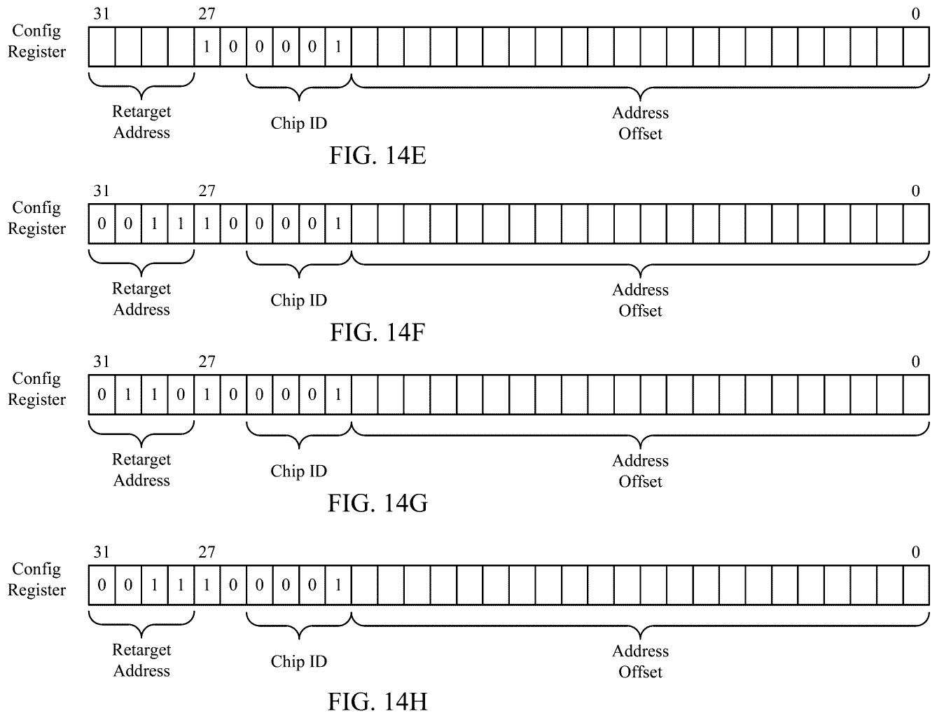

Referring now to FIGS. 14A-14H, an example of writing control information from a host to a second accelerator processor, in accordance with aspects of the present technology is shown. The host processor can send the control address from memory to its control out (CO) port (e.g., PCIe). The address sent to the output port (e.g., PCIe) can have the first and second control bits 710, 720 set to a second state (e.g., 11) to specify a configuration write, and the chip identifier portion set to specify the destination to be a second accelerator processor (e.g., chip ID 0001), as illustrated in FIG. 14A. In one implementation, the write may include writing 0x31000000 to an accelerator wrapper register. At the output port, the host processor can set the retarget address portion to indicate the control input (CI) port (e.g., 0011), as illustrated in FIG. 14B. Upon receipt of the address at the control input (CI) port of the first accelerator processor, the address can be decoded to determine that it is a control information transmission to the second accelerator processor. The first accelerator processor will thereafter change the retarget address portion to indicate the control out (CO) port, as illustrated in FIG. 14C, and transmit the address and control information to its control output (CO) (e.g., PCIe). At the second accelerator processor (CI) port, the first accelerator processor can set the retarget address portion to indicate the control input (CI) port (e.g., 0011), as illustrated in FIG. 14D. The control information is then written to initiate reading control information from a second accelerator processor, starting with the host processor sending the address to its output port (e.g., PCIe) with the first control bit 710 set to the second state and the second control bit 720 set to the first state (e.g., 10) as illustrated in FIG. 14E. At the output port, the host processor can set the retarget address portion to indicate the control input (CI) port (e.g., 0011), as illustrated in FIG. 14F. Upon receipt of the address at the control input (CI) port of the first accelerator processor, the address can be decoded to determine that it is a control information transmission to the second accelerator processor. The first accelerator processor will thereafter change the retarget address portion to indicate the control out (CO) port, as illustrated in FIG. 14G, and transmit the address and control information to its control output (CO) (e.g., PCIe). At the second accelerator processor (CI) port, the first accelerator processor can set the retarget address portion to indicate the control input (CI) port (e.g., 0011), as illustrated in FIG. 14H to initiate reading control information from the second accelerator processor.

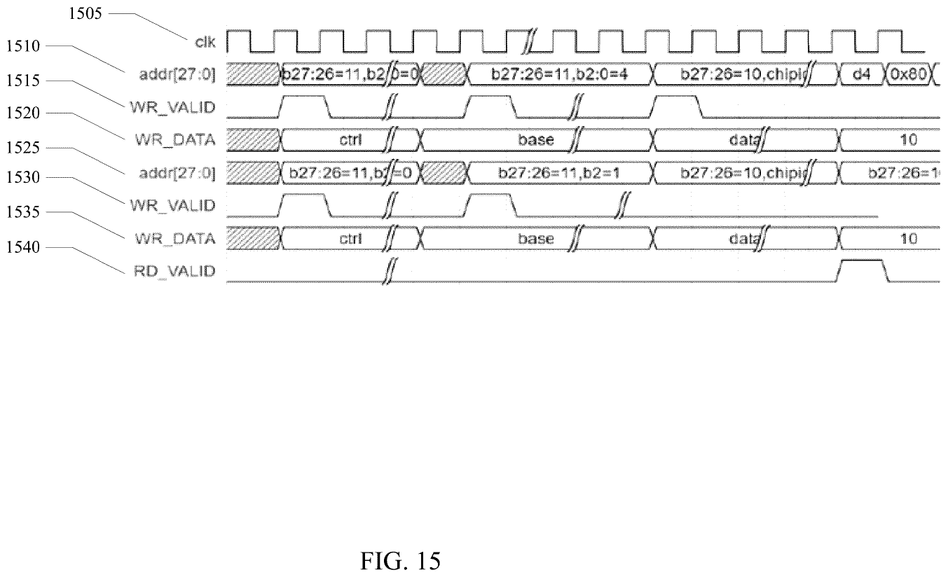

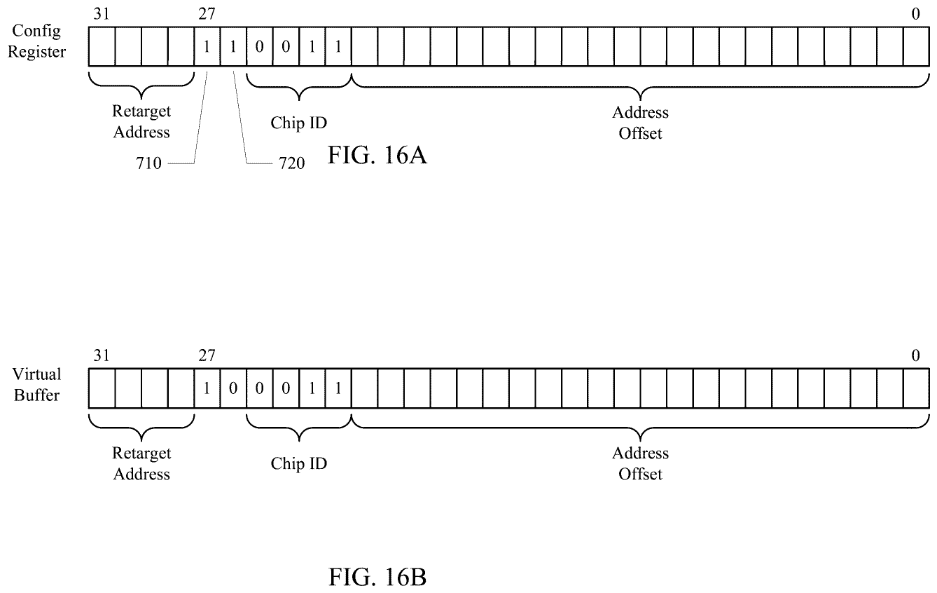

Referring now to FIG. 15, an exemplary waveform set for writing and reading control information from a host to a second accelerator, in accordance with aspects of the present technology, is shown. The sample waveform set includes a clock signal 1505 for synchronizing the other signals. The sample waveform set further includes a first address signal 1510, write valid signal 1515 and write data signal 1520. The sample waveform set also includes a second address signal 1525, write valid signal 1530, write data signal 1535 and read valid signal 1540. The write valid signals 1515, 1530 indicate at the falling edge when data on the write data signals 1520, 1535 is valid. The read valid signal 1540 indicates when read data is valid. Referring now to FIGS. 16A and 16B, an example of writing control information from a host to a third accelerator processor as illustrated in FIG. 15, in accordance with aspects of the present technology, is shown. A driver of the host processor first writes the on-chip base address of system memory to the address shown in FIG. 16A, wherein the first and second control bits 710, 720 are set to 11, and the chip identifier is set for a third accelerator processor. The driver of the host processor can then read from a given address in response to an address having first and second control bits 710, 720 set to 10, and the chip identifier specifying the third accelerator processor, as shown in FIG. 16B.

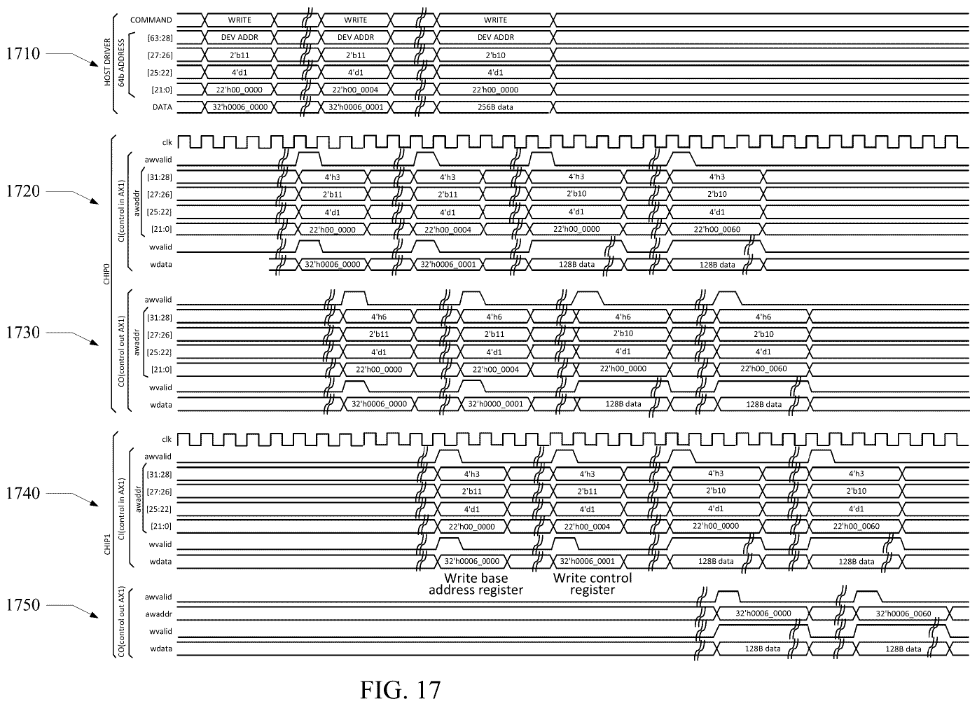

Referring now to FIG. 17, exemplary wave form sets for writing control information from a host processor to a second accelerator processor, in accordance with aspects of the present technology, is shown. The control information signaling illustrates writing from a host processor to a first accelerator processor (e.g., CHIP0), and from the first accelerator processor to a second accelerator processor (e.g., CHIP1). A first set of waveforms 1710 illustrates writing control information from an output port of the host processor. The second set of waveforms 1720 illustrates signaling for receiving the control information at the control input (CI) port of a first accelerator processor (e.g., chip 0). The third set of waveforms 1730 illustrates signaling for outputting the control information at the control out (CO) port of the first accelerator processor. The fourth set of waveforms 1740 illustrates signaling for receiving the control information at the control input (CI) port of the second accelerator processor. The fifth set of waveforms 1750 illustrates signaling for writing control information to the other components, for example the memory 340 on the second accelerator processor.

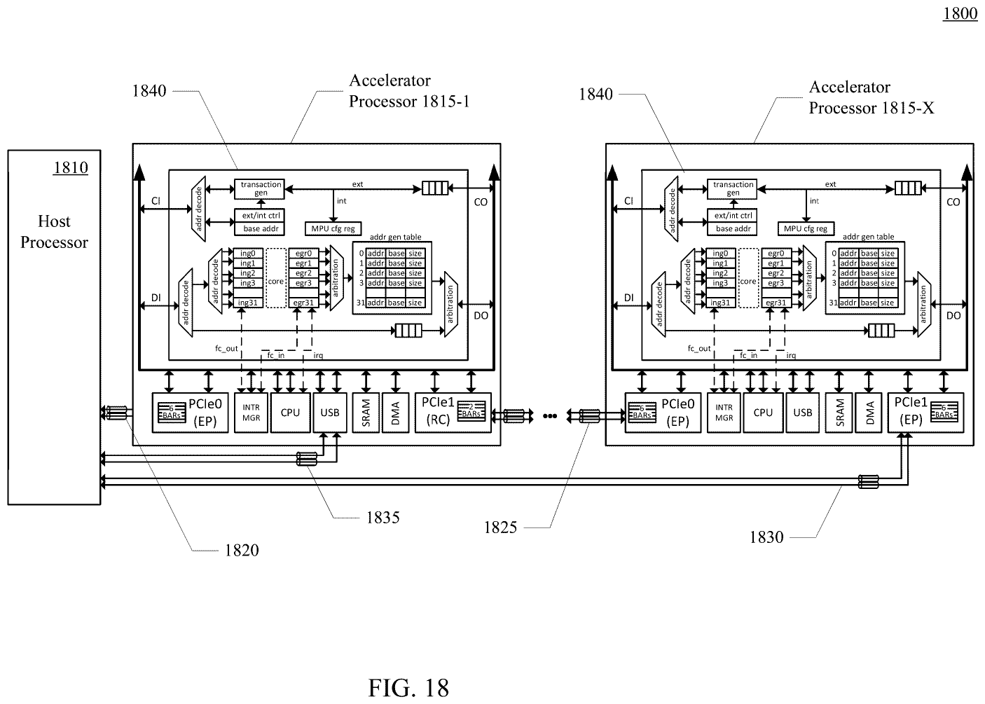

Referring now to FIG. 18, a computing device, in accordance with aspects of the present technology, is shown. The computing device 1800 can include a host processor 1810 and a plurality of accelerator processors 1815-1, 1815-X coupled in series to the host processor 1810 by a plurality of communication channels 1820-1835. In one implementation, the host processor 1810 and the plurality of accelerator processors 1815-1, 1815-X are coupled in series with a last accelerator processor 1815-X coupled back to the host processor 1810 by a series of peripheral component interface express (PCIe) communication links 1820-1830. The accelerator processors 1815-1, 1815-X can include a plurality of functional modules coupled by one or more communication buses. The functional modules can include, but are not limited to, one or more central processing units (CPUs), one or more memory processing units (MPUs), one or more memories, one or more memory management unit (e.g., direct memory access (DMA)), one or more controllers (e.g., integrated manager), one or more communication interfaces and the like as described above with regard to FIGS. 3-6. The host processor can similarly include a plurality of functional modules coupled by one or more communication buses.

The one or more memory processing units (MPUs) 1840 of each accelerator processor 1815-1, 1815-X can include a control in (CI), a control out (CO) port, a data in (DI), a date out (DO) port, a first, second and third address decoders, a transaction generation module, an external/internal control register, a base address register, an accelerator configuration register, a plurality of ingress registers, one or more cores, a plurality of egress registers, first and second arbitration modules, an address generation table, a control out buffer and a data out buffer as described above with regard to FIGS. 8 and 9. In one implementation, the one or more memory processing units (MPUs) 1840 or one or more cores therein can further include the memory processing units as described in U.S. patent application Ser. No. 17,943,100 filed Sep. 12, 2022, and U.S. patent application Ser. No. 18/109,736 filed Feb. 14, 2023, both of which are incorporated herein by reference.

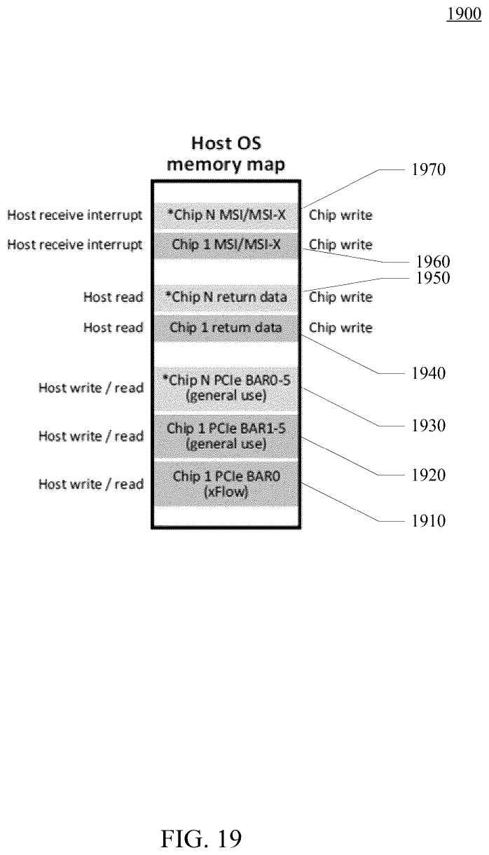

Referring now to FIG. 19, an exemplary memory space of a host processor, in accordance with aspects of the present technology, is shown. In one implementation, a host operating system (OS) memory map 1900 can include a portion of memory space allocated to a first base address register (BAR) for a communication interface 1910 of first accelerator processor. In one implementation, the first base address register (BAR0) can be allocated for address retargeting of a peripheral component interface express (PCIe) communication interface of the first accelerator processor. The memory portion allocated to the first base address register (BAR) for the communication interface 1910 of the first accelerator processor can be written to and read by the host processor. A second portion of the memory space can be allocated to additional base address registers (BAR1-5) for the communication interface (PCIe) 1920 of the first accelerator processor, and can be written to and read by the host processor for general use. Additional portions of the memory space can be allocated to additional base address registers (BAR0-5) for the communication interface (PCIe) 1930 of additional accelerator processors, and can be written to and read by the host processor for general use. The memory space can also include portions allocated for return data 1940, 1950 for the plurality of accelerator processors. The return data allocated portions can be utilized by the host for reading and for the respective accelerator processors for writing. The memory space can also include portions allocated for message signaled interrupts 1960, 1970 for the plurality of accelerator processors. The message signaled interrupt allocated portions of memory can be used by the host to receive interrupts and for the respective accelerator processor to write to.

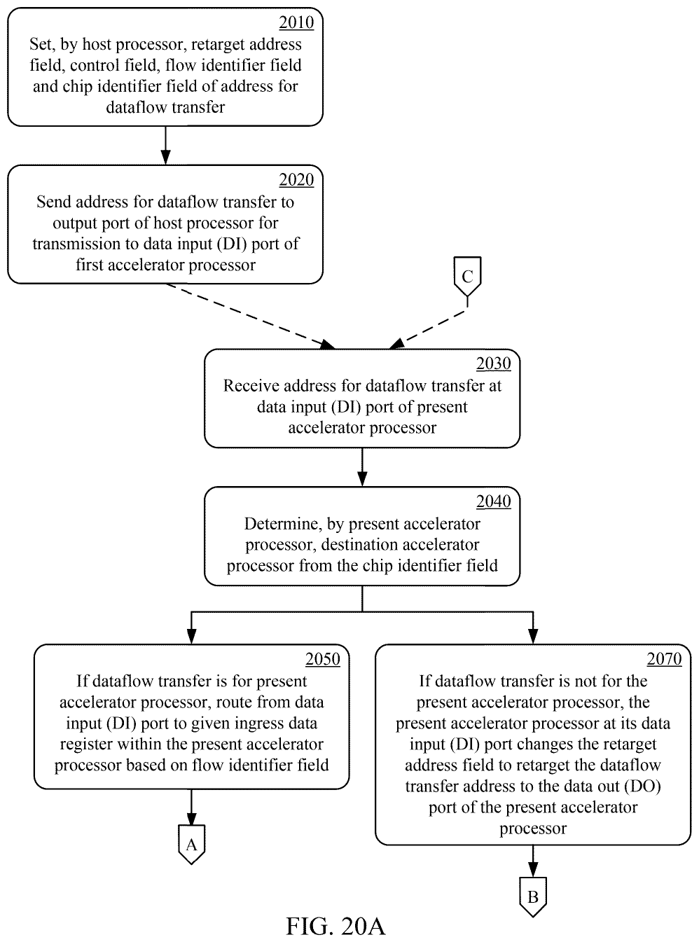

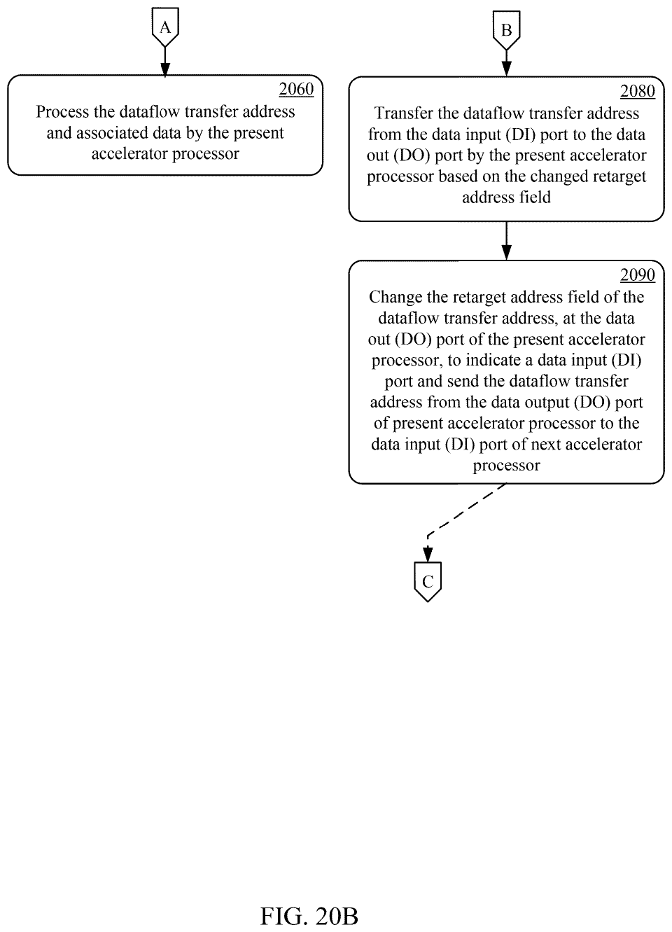

Referring now to FIGS. 20A-20B, a multi-processing unit data movement method, in accordance with aspects of the present technology, is shown. In one implementation, the multi-processing unit data movement may be a dataflow from a host processor to a given accelerator processor, as illustrated in FIGS. 3-6, and 18. Again, the accelerator processors can be slave processors, edge processors, coprocessors, controllers, graphics processors, digital signal processors, and the like. The accelerator processors can be configured in various implementations to accelerate one or more functions such as machine learning, artificial intelligence and the like functions. The host processor can set the retarget address field, control field, flow identifier field and chip identifier field of an address for a dataflow transfer, at 2010. For example, the host processor can set the retarget address field of the dataflow transfer address to 0011, the control bit to 0, the flow identifier field to 00000 to indicate a first ingress register, and the chip identifier field to 0000 to indicate a first accelerator processor. In a second example, the host processor can set the retarget address field of the dataflow transfer address to 0011, the control bit to 0, the flow identifier field to 11111 to indicate a thirty second ingress register, and the chip identifier field to 0000 to indicate a first accelerator processor. In a third example, the host processor can set the retarget address field of the dataflow transfer address to 0011, the control bit to 0, the flow identifier field to 00101 to indicate a fifth ingress register, and the chip identifier field to 0001 to indicate a second accelerator processor. It is to be appreciated that the flow identifier field is optional, and may not be implemented or may be implemented in other ways.

At 2020, the host sends the address for the dataflow transfer to its output port for transmission to a data input (DI) port of a first accelerator processor. At 2030, the first accelerator processor receives the address for the dataflow transfer at its data input (DI) port. At 2040, the first accelerator processor determines the destination accelerator process from the chip identifier field of the dataflow transfer address. For the first two examples, the first accelerator processor determines that the dataflow transfer is for the first accelerator processor based on the chip identifier field value of 0000. In the third example, the first accelerator processor determines that the dataflow transfer is for a second accelerator processor based on the chip identifier field value of 0001.

If the dataflow transfer is for the present accelerator processor, the dataflow transfer address is routed from the data input (DI) port of the present accelerator processor, to a given ingress data register within the present accelerator processor based on the flow identifier field. In the first example, the first accelerator processor determines that the dataflow transfer is for itself and routes the dataflow transfer address to a first ingress register of the first accelerator processor based on the flow identifier value of 00000 of the dataflow transfer address. In the second example, the first accelerator processor determines that the dataflow transfer is for itself and routes the dataflow transfer address to a thirty second ingress register of the first accelerator processor based on the flow identifier value of 11111 of the dataflow transfer address. Thereafter, the dataflow transfer address and associated data is processed by the present accelerator processor, at 2060.

If the dataflow transfer is not for the present accelerator processor, the present accelerator processor at its data input (DI) port changes the retarget address field to retarget the dataflow transfer address to the data out (DO) port of the present accelerator, at 2070. In the third example, the first accelerator processor determines that the dataflow transfer is for the second accelerator processor and the first accelerator processor changes the retarget address field value from 0011 to 0110 to retarget the dataflow transfer address to the data out (DO) port of the first accelerator processor. At 2080, the dataflow transfer address is transferred from the data input (DI) port to the data out (DO) port by the present accelerator based on the changed retarget address field. At 2090, the retarget address field of the dataflow transfer address is changed at the data out (DO) port of the present accelerator processor, to indicate a data input (DI) port and the changed dataflow transfer address is sent from the data output (DO) port of the present accelerator processor to the data input (DI) port of the next accelerator processor. For example, the present accelerator processor changes the retarget address field value from 0110 back to 0011, and then the changed dataflow transfer address is sent from the data output (DO) port of the present accelerator processor to the data input (DI) port of the next accelerator processor.

The processes at 2030-2090 can thereafter be iteratively performed to route the dataflow transfer address and associated data to the accelerator processor indicated in the chip identifier field, and subsequently, the ingress data register based on the flow identifier of the destination accelerator processor.

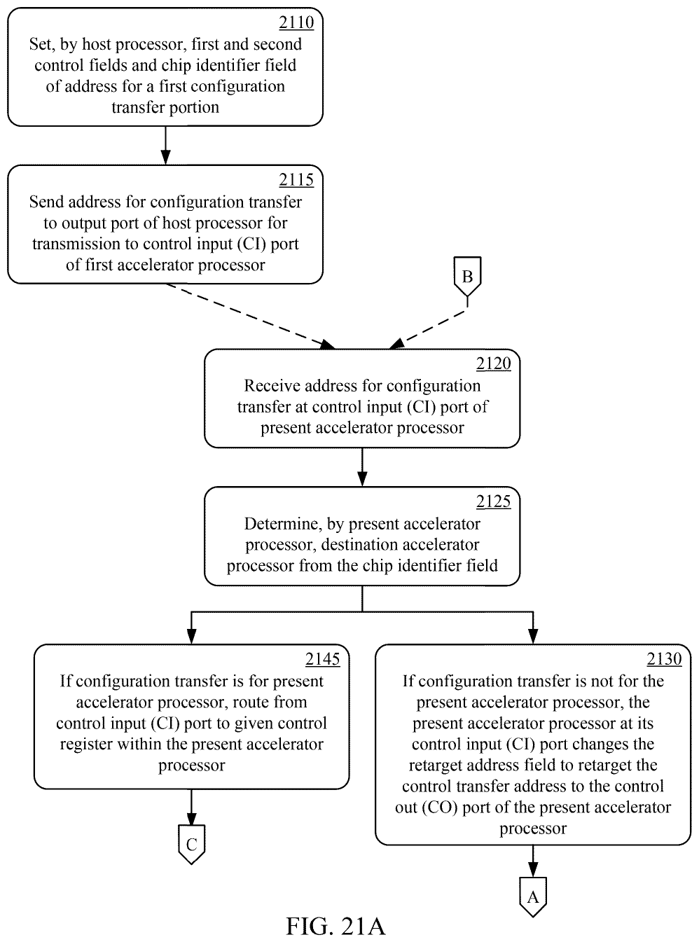

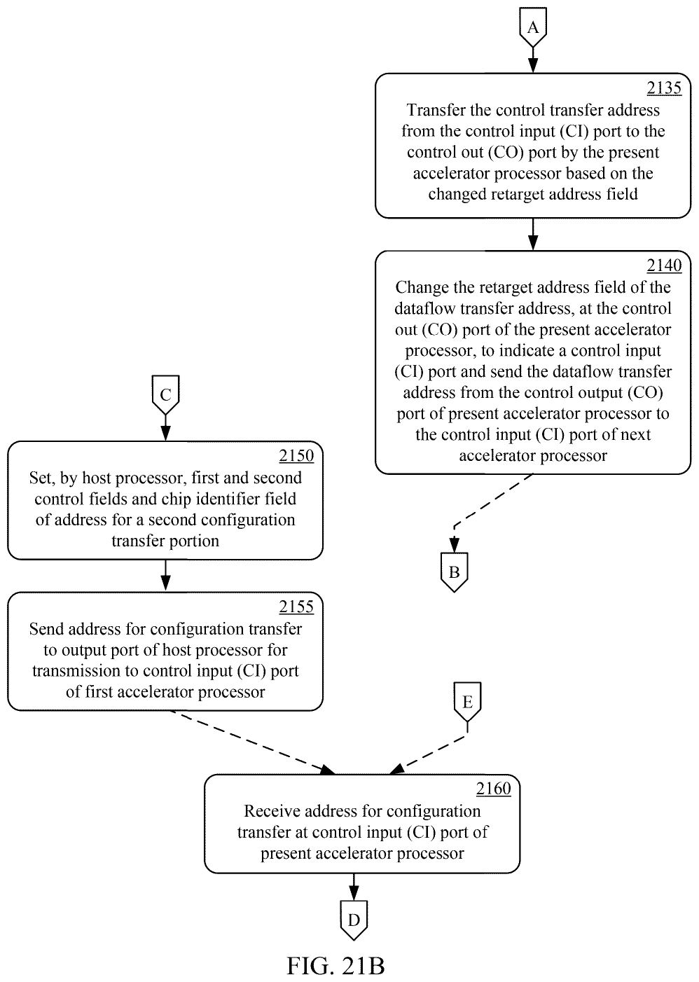

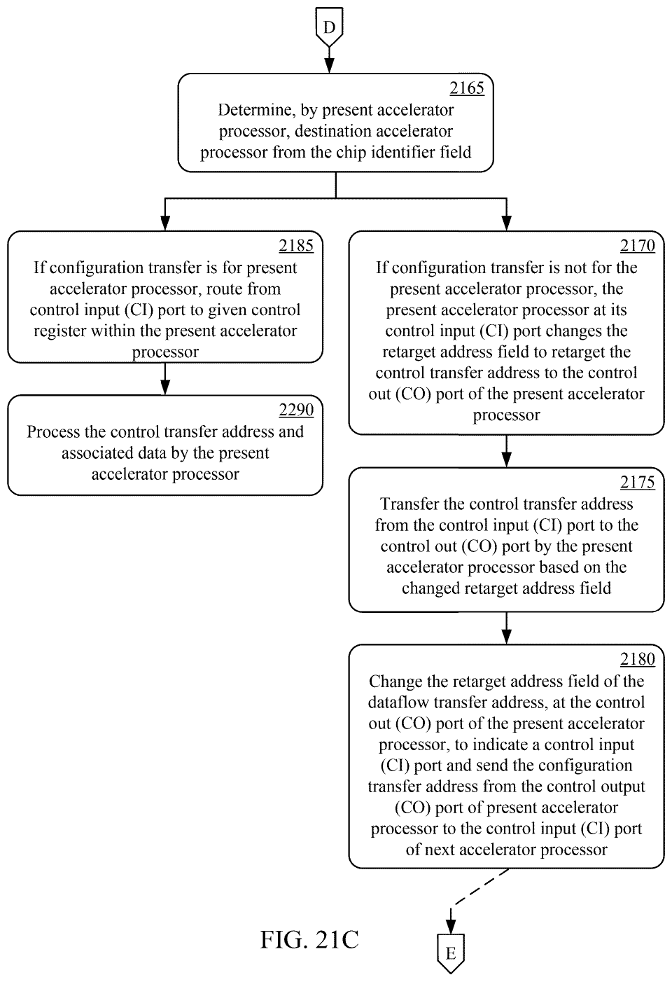

Referring now to FIGS. 21A-21B, a multi-processing unit data movement method, in accordance with aspects of the present technology, is shown. In one implementation, the multi-processing unit data movement may be a configuration transfer from a host processor 1810 to a given accelerator processor, as illustrated in FIGS. 3-6, and 18. Again, the accelerator processors can be slave processors, edge processors, coprocessors, controllers, graphics processors, digital signal processors, and the like. The accelerator processors can be configured in various implementations to accelerate one or more functions such as machine learning, artificial intelligence and the like functions. For a control information transfer, the transfer can include a first transfer portion for writing a predetermined value to a given register of a destination accelerator processor and a second transfer of the actual control data to the destination accelerator processor. For the first transfer portion, the host processor can set the first and second control fields and chip identifier field of an address for a control transfer, at 2110. For example, the host processor can set the first control bit to 1 to indicate a transfer to a configuration input, the second control bit to 1 to indicate a transfer to a configuration output, and the chip identifier field to 0001 to indicate a second accelerator. In one implementation, the configuration transfer can write a value of 0x31000000 to a wrapper register of a processing core of a given accelerator processor.

At 2115, the host sends the address for the configuration transfer to its output port for transmission to a control input (CI) port of a first accelerator processor. At 2120, the first accelerator processor receives the address for the control transfer at its control input (CI) port. At 2125, the first accelerator processor determines the destination accelerator process from the chip identifier field of the control transfer address. For example, the first accelerator processor determines that the control transfer is for a second accelerator processor based on the chip identifier field value of 0001.

If the control transfer is not for the present accelerator processor, the present accelerator processor at its control input (CI) port changes the retarget address field to retarget the control transfer address to the control out (CO) port of the present accelerator, at 2130. For example, the first accelerator processor determines that the control transfer is for the second accelerator processor and the first accelerator processor changes the retarget address field value from 0011 to 0110 to retarget the dataflow transfer address to the control out (CO) port of the first accelerator processor. At 2135, the control transfer address is transferred from the control input (CI) port to the control out (CO) port by the present accelerator based on the changed retarget address field. At 2140, the retarget address field of the dataflow transfer address is changed at the control out (CO) port of the present accelerator processor to indicate a control input (CI) port and the changed dataflow transfer address is sent from the control output (CO) port of the present accelerator processor to the control input (CI) port of the next accelerator processor. For example, the present accelerator processor changes the retarget address field value from 0110 back to 0011, and then the changed control transfer address is sent from the control output (CO) port of the present accelerator processor to the control input (CI) port of the next accelerator processor. The processes at 2120-2140 can thereafter be iteratively performed to route the control transfer address and associated data to the accelerator processor indicated in the chip identifier field.

If the control transfer is for the present accelerator processor, the control transfer address is routed from the control input (CI) port to a given control register of the present accelerator processor, at 2145. For example, the second accelerator processor determines that the control transfer is for itself and routes the control transfer address to a configuration register of the accelerator processor.

For the second transfer portion, the host processor can set the first and second control fields and chip identifier field of an address for the control transfer, at 2150. For example, the host processor can set the first control bit to 1 to indicate a transfer to a configuration input, the second control bit to 0 to indicate a transfer to a configuration input, and the chip identifier field to 0001 to indicate the second accelerator.

At 2155, the host sends the address for the second portion of the configuration transfer to its output port for transmission to a control input (CI) port of the first accelerator processor. At the output port, the host sets the retarget address to indicate the control input (CI) port. For example, the host can set the retarget address to 0011 to indicate the control input (CI) port. At 2160, the first accelerator processor receives the address for the second portion of the control transfer at its control input (CI) port. At 2165, the first accelerator processor determines the destination accelerator process from the chip identifier field of the control transfer address. For example, the first accelerator processor determines that the second portion of the control transfer is for the second accelerator processor based on the chip identifier field value of 0001.

If the second portion of the control transfer is not for the present accelerator processor, the present accelerator processor at its control input (CI) port changes the retarget address field to retarget the control transfer address to the control out (CO) port of the present accelerator, at 2170. For example, the first accelerator processor determines that the control transfer is for the second accelerator processor and the first accelerator processor changes the retarget address field value from 0011 to 0110 to retarget the configuration transfer address to the control out (CO) port of the first accelerator processor. At 2175, the control transfer address is transferred from the control input (CI) port to the control out (CO) port by the present accelerator based on the changed retarget address field. At 2180, the retarget address field of the dataflow transfer address is changed at the control out (CO) port of the present accelerator processor, to indicate a control input (CI) port and the changed dataflow transfer address is sent from the control output (CO) port of the present accelerator processor to the control input (DI) port of the next accelerator processor. For example, the present accelerator processor changes the retarget address field value from 0110 back to 0011, and then the changed control transfer address is sent from the control output (CO) port of the present accelerator processor to the control input (CI) port of the next accelerator processor. The processes at 2160-2180 can thereafter be iteratively performed to route the control transfer address and associated data to the accelerator processor indicated in the chip identifier field.

If the control transfer is for the present accelerator processor, the control transfer address is routed from the control input (CI) port of the present accelerator processor, at 2185. For example, the second accelerator processor determines that the control transfer is for itself and routes the control transfer address to a control register of the second accelerator processor based on the chip flow identification value of 0001 of the control transfer address. At 2290, the present accelerator processor can process the control transfer address and associated data.

Aspects of the present technology advantageously support different types of read and write transactions. A consistent memory map can advantageously be seen by the host processor regardless of the number of accelerator processors. Aspects advantageously enable a host driver to stream data to the plurality of accelerator processors. Configuration data can tolerate relatively large latency, and stream data can be sent quickly and efficiently. In aspects, efficient data movement can advantageously be controlled by hardware.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

1. A multi-processor data movement method comprising:
setting a retarget address field of a transfer address one or more times to a dataspace of one or more processors;
setting one or more control fields to indicate a dataflow transfer or a configuration transfer;
setting a chip identifier field to indicate a destination accelerator processor; and
routing the transfer address to the destination accelerator processor based on the retarget address field, the one or more control fields and the chip identifier field.

2. The multi-processor data movement method according to claim 1, further comprising:
setting a flow identifier field for the dataflow transfer; and
routing the transfer address to the destination processor further based on the flow identifier field.

3. The multi-processor data movement method according to claim 2, further comprising:
setting, by a host processor, the retarget address field, the one or more control fields, the flow identifier field and the chip identifier field of the transfer address for the dataflow transfer;
sending the transfer address for the dataflow transfer to a data output port of the host processor for transmission to a data input port of a first accelerator processor;
receiving the transfer address at the data input port of the first accelerator processor;
determining by the first accelerator processor the destination accelerator processor from the chip identifier field of the transfer address; and
routing the transfer address from the data input port to a given ingress data register within the first accelerator processor based on the flow identifier field when the destination accelerator processor of the dataflow transfer is determined to be the first accelerator processor.

4. The multi-processor data movement method according to claim 3, further comprising:
change the retarget address field to retarget the transfer address of the dataflow transfer from a data input port to a data output port of the first accelerator processor;
sending the transfer address for the dataflow transfer to a data output port of the first accelerator processor for transmission to a data input port of a second accelerator processor;
receiving the transfer address at the data input port of the second accelerator processor;
determining by the second accelerator processor the destination accelerator processor from the chip identifier field of the transfer address.

5. The multi-processor data movement method according to claim 1, further comprising:
setting, by a host processor, the retarget address field, the one or more control fields, and the chip identifier field of the transfer address for a first portion of the configuration transfer;
sending the transfer address for the first portion of the configuration transfer to an output port of the host processor for transmission to a control input port of a first accelerator processor;
receiving the transfer address at the control input port of the first accelerator processor;
determining by the first accelerator processor the destination accelerator processor from the chip identifier field of the transfer address of the first portion of the configuration transfer; and
routing the transfer address from the control input port to a given control register within the first accelerator processor when the destination accelerator processor of the configuration transfer is determined to be the first accelerator processor.

6. The multi-processor data movement method according to claim 5, further comprising:
changing the retarget address field to retarget the transfer address of the first portion of the configuration transfer from a control input port to a control output port of the first accelerator processor;
sending the transfer address of the first portion of the configuration transfer to a control output port of the first accelerator processor for transmission to a control input port of a second accelerator processor;
receiving the transfer address of a second portion of the configuration transfer at the control input port of the second accelerator processor; and
determining by the second accelerator processor the destination accelerator processor from the chip identifier field of the transfer address of the first portion of the configuration transfer.

7. The multi-processor data movement method according to claim 5, further comprising:
setting, by the host processor, the retarget address field, the one or more control fields, and the chip identifier field of the transfer address for a second portion of the configuration transfer;
sending the transfer address for the second portion of the configuration transfer to an output port of the host processor for transmission to a control input port of the first accelerator processor;
receiving the transfer address at the control input port of the first accelerator processor;
determining by the first accelerator processor the destination accelerator processor from the chip identifier field of the transfer address of the second portion of the configuration transfer; and
routing the transfer address from the control input port to a given control register within the first accelerator processor when the destination accelerator processor of the configuration transfer is determined to be the first accelerator processor.

8. The multi-processor data movement method according to claim 7, further comprising:
changing the retarget address field to retarget the transfer address of the second portion of the configuration transfer from a control input port to a control output port of the first accelerator processor;
sending the transfer address of the second portion of the configuration transfer to a control output port of the first accelerator processor for transmission to a control input port of a second accelerator processor;
receiving the transfer address of the second portion of the configuration transfer at the control input port of the second accelerator processor; and
determining by the second accelerator processor the destination accelerator processor from the chip identifier field of the transfer address of the second portion of the configuration transfer.

9. A multi-processor computing device comprising:
a host processor;
one or more accelerator processors coupled in series to the host processor by respective communication interfaces that support configuration transfers and dataflow transfers.

10. The multi-processor computing device of claim 9, wherein the host processor programs a first accelerator processor with a first portion of a computation model and a second accelerator processor with a second portion of the computation model.

11. The multi-processor computing device of claim 9, wherein the host processor programs a first accelerator processor with a first computation model and a second accelerator processor with a second computation model.

12. The multi-processor computing device of claim 9, wherein the configuration transfers and the dataflow transfers between the host processor and the one or more accelerator processors include a transfer address comprising a retarget address field identifying a given memory space of the host processor and the accelerator processors, a first control field identifying the transfer address as a configuration transfer address or a dataflow transfer address, and a chip identifier field identifying a destination accelerator processor.

13. The multi-processor computing device of claim 12, wherein the configuration transfer address further includes a second control field identifying an accelerator processor or other component.

14. The multi-processor computing device of claim 12, wherein the dataflow transfer address further includes a flow identifier field identifying a given one of a plurality of data in buffers or a given one of a plurality of data out buffers.

15. The multi-processor computing device of claim 12, wherein the given memory space of the host processor and the accelerator processors include an address space of a data input port of the accelerator processors, an address space of a control input port of the accelerator processors, an address space of an output data port of the accelerator processors, and an address space of an output control port of the accelerator processors.

16. The multi-processor computing device of claim 12, wherein:
the host processor sets the retarget address field, the first control field, the first control field and the chip identifier field of the transfer address for the dataflow transfers;
the host processor sends the transfer address for the dataflow transfer to a data output port of the host processor for transmission to a data input port of a first accelerator processor based on the first control field;
the first accelerator processor receives the transfer address at the data input port of the first accelerator processor;
the first accelerator processor determines a destination accelerator processor from the chip identifier field of the transfer address;
the first accelerator processor routes the transfer address from the data input port to a given ingress data register within the first accelerator processor based on the first control field when the destination accelerator processor of the dataflow transfer is determined to be the first accelerator processor;
the first accelerator processor changes the retarget address field to retarget the transfer address of the dataflow transfer from a data input port to a data output port of the first accelerator processor when the destination accelerator processor of the dataflow transfer is determined to be a second accelerator processor;
the first accelerator processor sends the transfer address for the dataflow transfer to a data output port of the first accelerator processor for transmission to a data input port of a second accelerator processor when the destination accelerator processor of the dataflow transfer is determined to be the second accelerator processor;
the second accelerator processor receives the transfer address at the data input port of the second accelerator processor when the destination accelerator processor of the dataflow transfer is determined to be the second accelerator processor; and
the second accelerator processor determines by the second accelerator processor the destination accelerator processor from the chip identifier field of the transfer address when the destination accelerator processor of the dataflow transfer is determined to be the second accelerator processor.

17. The multi-processor computing device of claim 16, wherein:
the host processor sets the retarget address field, the one or more control fields, and the chip identifier field of the transfer address for a first portion of the configuration transfers;
the host processor sends the transfer address for the first portion of the configuration transfer to an output port of the host processor for transmission to a control input port of a first accelerator processor;
the first accelerator processor receives the transfer address at the control input port of the first accelerator processor;
the first accelerator processor determines the destination accelerator processor from the chip identifier field of the transfer address of the first portion of the configuration transfer;
the first accelerator processor routes the transfer address from the control input port to a given control register within the first accelerator processor when the destination accelerator processor of the configuration transfer is determined to be the first accelerator processor;
the first accelerator processor changes the retarget address field to retarget the transfer address of the first portion of the configuration transfer from a control input port to a control output port of the first accelerator processor when the destination accelerator processor of the configuration transfer is determined to be the second accelerator processor;
the first accelerator processor sends the transfer address of the first portion of the configuration transfer to a control output port of the first accelerator processor for transmission to a control input port of the second accelerator processor when the destination accelerator processor of the configuration transfer is determined to be the second accelerator processor;
the second accelerator processor receives the transfer address of the first portion of the configuration transfer at the control input port of the second accelerator processor when the destination accelerator processor of the configuration transfer is determined to be the second accelerator processor;
the second accelerator processor determines by the second accelerator processor the destination accelerator processor from the chip identifier field of the transfer address of the first portion of the configuration transfer.

18. The multi-processor computing device of claim 17, wherein:
the host processor sets the retarget address field, the one or more control fields, and the chip identifier field of the transfer address for a second portion of the configuration transfer;
the host processor sends the transfer address for the second portion of the configuration transfer to an output port of the host processor for transmission to a control input port of the first accelerator processor;
the first accelerator processor receives the transfer address at the control input port of the first accelerator processor;
the first accelerator processor determines by the first accelerator processor the destination accelerator processor from the chip identifier field of the transfer address of the second portion of the configuration transfer;
the first accelerator processor routes the transfer address from the control input port to a given control register within the first accelerator processor when the destination accelerator processor of the configuration transfer is determined to be the first accelerator processor;
the first accelerator processor changes the retarget address field to retarget the transfer address of the second portion of the configuration transfer from a control input port to a control output port of the first accelerator processor when the destination accelerator processor of the configuration transfer is determined to be the second accelerator processor;
the first accelerator processor sends the transfer address of the second portion of the configuration transfer to a control output port of the first accelerator processor for transmission to a control input port of the second accelerator processor when the destination accelerator processor of the configuration transfer is determined to be the second accelerator processor;
the second accelerator processor receives the transfer address of the second portion of the configuration transfer at the control input port of the second accelerator processor when the destination accelerator processor of the configuration transfer is determined to be the second accelerator processor; and
the second accelerator processor determines by the second accelerator processor the destination accelerator processor from the chip identifier field of the transfer address of the second portion of the configuration transfer when the destination accelerator processor of the configuration transfer is determined to be the second accelerator processor.
